(19) United States
(12) Patent Application Publication
(10) Pub. No.: US 2006/0210839 A1
(43) Pub. Date: Sep. 21, 2006

(54) Magnetic recording medium

(75) Inventors: Tsutomu Ide, Tokyo (JP); Katsuhiko Yamazaki, Tokyo (JP); Tomoyuki Kotaki, Tokyo (JP); Sadafumi Iijima, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/374,061

(22) Filed: Mar. 14, 2006

(30) Foreign Application Priority Data
Mar. 15, 2005 (JP) 2005-072274

(51) Int. Cl. G11B 5/716

(52) U.S. Cl. 428/840.4

(57) ABSTRACT

A magnetic recording medium which makes it possible to further increase the recording capacity while maintaining a required flexibility thereof. A magnetic tape has a lower non-magnetic layer and a magnetic layer formed on one surface of a base film in the mentioned order. The lower non-magnetic layer is formed of a non-magnetic coating material containing a non-magnetic powder, an electron beam curing binder, a dispersant having an amine group, and a thermosetting agent.

### BACKGROUND OF THE INVENTION

1. Field of the Invention

The present invention relates to a magnetic recording medium having a lower non-magnetic layer and a magnetic layer formed on a non-magnetic substrate in the mentioned order.

2. Description of the Related Art

As a magnetic recording medium of this kind, there is known a magnetic recording medium (magnetic tape) disclosed in Japanese Laid-Open Patent Publication (Kokai) No. 2004-272992. In this magnetic recording medium, a predetermined substance is contained in a lower non-magnetic layer as a dispersant together with a non-magnetic inorganic powder and carbon black, so as to enhance dispersibility of the non-magnetic inorganic powder and carbon black in a lower non-magnetic layer, whereby excellent surface properties, electromagnetic conversion characteristics, and running durability are attained. Further, in the magnetic recording medium, by employing a wet-on-dry coating method where a magnetic layer is coated after a non-magnetic layer is cured, the surface properties of the both layers (the lower non-magnetic layer and the magnetic layer) are highly controlled whereby recording density is improved. In this case, an electron beam curing binder is contained as a binder in the lower non-magnetic layer so as to cure the lower non-magnetic layer by irradiating an electron beam.

### SUMMARY OF THE INVENTION

Now, in recent years, to cope with an increase in the amount of data to be recorded, there is a demand for a further increase in recording capacity per one cartridge of magnetic recording medium. As a method of increasing the recording capacity of a magnetic recording medium, it is considered to reduce the entire thickness of the magnetic recording medium by reducing the film thickness of the non-magnetic substrate thereof to thereby increase the length of the magnetic recording medium housed in a cartridge case.

As a result of study on the above-mentioned conventional magnetic recording medium, however, the present inventors found that the following problems occur when the length of the magnetic recording medium is increased by reducing the film thickness of the non-magnetic substrate: In general, to ensure accurate positioning of a magnetic head on a track, the Young's modulus of a magnetic recording medium is required to be not less than a specified Young's modulus value so as to hold the amount of the expansion/contraction due to application of a tensile force or a change in ambient temperature within a reference value. Particularly in recent years, the number of tracks has been increased for enhancement of recording density of the magnetic recording medium, which narrows the pitch of tracks, therefore it is important to maintain the Young's modulus of the magnetic recording medium not less than the specified value. However, the reduction of the film thickness of the non-magnetic substrate makes the magnetic recording medium susceptible to thermal contraction during the manufacturing process thereof, and causes reduction of its Young's modulus, which also reduces the Young's modulus of the entire magnetic recording medium. As a consequence, there is a risk of the margin between the Young's modulus of the entire magnetic recording medium and the specified value becoming so small, and in a worst case, the Young's modulus of the entire magnetic recording medium might become less than the specified value. Therefore, to avoid such a problem, it is required to increase the strength of layers (the lower non-magnetic layer and the magnetic layer) formed on the non-magnetic substrate to thereby compensate for reduction of the Young's modulus of the non-magnetic substrate and maintain the Young's modulus of the entire magnetic recording medium not less than the specified value. At the same time, the magnetic recording medium is required to be flexible, and hence it is necessary to maintain the Young's modules thereof not larger than an upper limit within which a required flexibility is ensured, while maintaining the Young's modulus thereof not less than the specified value

The present invention has been made to solve the problems described above, and a main object thereof is to provide a magnetic recording medium which makes it possible to further increase recording capacity while maintaining a required flexibility thereof.

To attain the above object, the present invention provides a magnetic recording medium having at least a lower non-magnetic layer and a magnetic layer formed on one surface of a non-magnetic substrate in the mentioned order, wherein the lower non-magnetic layer is formed of a non-magnetic coating material containing at least a non-magnetic powder, an electron beam curing binder, a dispersant having an amine group, and a thermosetting agent. It should be noted that the magnetic recording medium according to the present invention is not limited to a magnetic recording medium having only the lower non-magnetic layer and the magnetic layer formed on the non-magnetic substrate, but the present invention encompasses magnetic recording media having various functional layers formed between the non-magnetic substrate and the lower non-magnetic layer, magnetic recording media having various functional layers formed between the lower non-magnetic layer and the magnetic layer, and magnetic recording media having various functional layers formed on the magnetic layer.

With the arrangement of this magnetic recording medium since the lower non-magnetic layer is formed of the non-magnetic coating material containing an electron beam curing binder as a binder, a dispersant having an amine group, and a thermosetting agent, it is possible to form the magnetic layer on the lower non-magnetic layer cured by an electron beam by a wet-on-dry coating method, which makes it possible to realize a magnetic recording medium having excellent surface smoothness and electromagnetic conversion characteristics. Further, the lower non-magnetic layer is not only cured by the electron beam, but also further cured by crosslinking reaction between the dispersant having the amine group and the thermosetting agent through thermosetting thereof. As a result, the Young's modulus of the entire magnetic recording medium can be maintained not less than the specified value by increasing the strength of the lower non-magnetic layer even when the film thickness of the non-magnetic substrate is reduced, which makes it possible to further increase recording capacity. It should be noted that the advantageous effects of the present invention can be provided when an electron beam curing resin agent, a dispersant, and a thermosetting agent are contained in a binder as described hereinabove, and hence it is impossible to provide the same advantageous effects as provided by the present invention when a dispersant having no amine group is used, or when a thermosetting binder is used in place of the electron beam curing binder even if the dispersant has an amine group.

Preferably, the content of the dispersant is set within a range of 1 part by weight to 6 parts by weight, inclusive, per 100 parts by weight of the non-magnetic powder.

Preferably, the content of the thermosetting agent is set within a range of 0.2 parts by weight to 2 parts by weight, inclusive, per 1 part by weight of the dispersant.

When the dispersant content is set as above, the strength of the lower non-magnetic layer is increased. As result, it is possible to maintain the Young's modulus of the entire magnetic recording medium not less than the specified value. Similarly, when the thermosetting agent content is set as above, the strength of the lower non-magnetic layer is increased. As a result, it is possible to maintain the Young's modulus of the entire magnetic recording medium not less than the specified value.

It should be noted that the present disclosure relates to the subject matter included in Japanese Patent Application No. 2005-072274 filed Mar. 15, 2005, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape as an example of a magnetic recording medium according to an embodiment of the present invention;

FIG. 2 is a characteristics diagram showing the relationship between load P on the magnetic tape in FIG. 1 and indentation depth h measured using an ultra-micro indentation hardness tester;

FIG. 3 is a diagram useful in explaining dispersant content per 100 parts by weight of a non-magnetic powder and thermosetting agent content per 1 part by weight of the dispersant in Examples and Comparative Examples;

FIG. 4 is a diagram useful in explaining dispersant content per 100 parts by weight of a non-magnetic powder and thermosetting agent content per 1 part by weight of the dispersant in Comparative Examples;

FIG. 5 is a diagram showing results of measurement of Young's moduli E1, E2 in Examples; and

FIG. 6 is a diagram showing results of measurement of Young's moduli E1, E2 in Comparative Examples.

### DESCRIPTION OF THE PREFERRED EMBODIMENTS

The invention will now be described in detail with reference to the accompanying drawings showing a preferred embodiment thereof.

First, a description will be given of the construction of a magnetic tape 1 as an example of a magnetic recording medium according to the present invention with reference to the drawings.

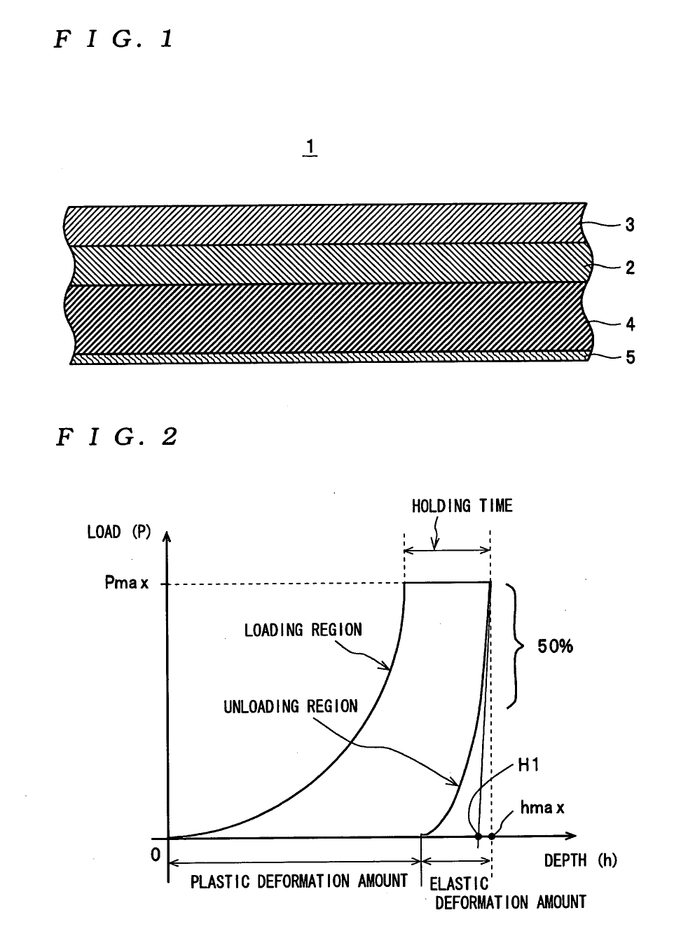

The magnetic tape 1 shown in FIG. 1 has a lower non-magnetic layer 2 and a magnetic layer 3 formed on one surface (upper surface as viewed in FIG. 1) of a base film (non-magnetic substrate according to the present invention) 4 in the mentioned order so that the magnetic tape 1 can be used by a recording/reproducing apparatus, not shown, to record and reproduce various record data. Further, the magnetic tape 1 has a back coat layer 5 formed on the other surface (lower surface as viewed in FIG. 1) of the base film 4 so as to improve tape-running performance as well as to prevent the base film 4 from being damaged by scratching (and worn out) and the magnetic tape 1 from being electrically charged. It should be noted that in FIG. 1, for purposes of ease of understanding of the present invention, the thickness of the magnetic tape 1 is exaggerated, and the thickness ratio of the layers is illustrated differently from the actual thickness ratio. In this case, to improve the adhesiveness of the lower non-magnetic layer 2 to the base film 4, an undercoat layer (easy adhesive layer) may be provided between the base film 4 and the lower non-magnetic layer 2.

(Base Film)

The base film 4 is in the form of a long belt and made of resin materials including polyesters such as polyethylene terephthalate (PET) and polyethylene naphthalate (PEN), polyolefins such as polypropylene, polyamides, polyimides, polyamide-imides, polysulfone-cellulose triacetates, and polycarbonates. In this case, after the layers have been completely formed, the base film 4 is cut together with the layers to a predetermined width specified for each of various types of magnetic recording media. In order to increase recording capacity, the base film 4 is preferably formed with a thickness set within a range of 3.0 μm to 10.0 μm, inclusive. Although in the present embodiment, the base film 4 is configured to have a long belt shape (tape shape), the base film 4 may be configured to have any of a sheet shape, a card shape, a disk shape, and various other shapes.

(Lower Non-magnetic Layer)

The lower non-magnetic layer 2 is coated with a non-magnetic coating material containing a non-magnetic powder, an electron beam curing binder, a dispersant, and a thermosetting agent, so as to have a thickness within a range of 0.3 μm to 2.5 μm, inclusive. In this case, if the thickness of the lower non-magnetic layer 2 is less than 0.3 μm, the lower non-magnetic layer 2 tends to be easily affected by the surface roughness of the base film 4. As a consequence, the surface smoothness of the lower non-magnetic layer 2 is degraded, and the surface smoothness of the magnetic layer 3 is more easily degraded, thereby causing degradation of electromagnetic conversion characteristics, which makes it difficult to record data normally. Further, since the light transmittance of the lower non-magnetic layer 2 is increased, it is difficult to detect the end of the magnetic tape by making use of a change in the light transmittance. On the other hand, even if the lower non-magnetic layer 2 is formed with a thickness of more than 2.5 μm, it cannot be expected that the recording characteristics of the magnetic tape 1 are dramatically improved, and what is worse, it becomes difficult to form the lower non-magnetic layer 2 with a uniform thickness. Furthermore, it is necessary to use a large amount of non-magnetic coating material to form the lower non-magnetic layer 2, which causes an increase in manufacturing costs.

As the non-magnetic powder, carbon black and various kinds of non-magnetic inorganic powders other than carbon black can be used. Examples of carbon black that can be employed include a furnace black for rubber, a thermal black for rubber, a black for coloring, an acetylene black, etc. In this case, the carbon black preferably has a BET specific surface area within a range of 5 m²/g to 600 m²/g, a DBP oil absorption within a range of 30 ml/100 g to 400 ml/100 g, and an average particle diameter within a range of 10 nm to 100 nm, inclusive. The carbon black that can be used as the non-magnetic powder can be specifically determined by referring to “Carbon Black Handbook” (compiled by Carbon Black Association). Further, the compounding amount of carbon black in the lower non-magnetic layer 2 is only required to be within a range of 5 wt % to 30 wt %, and preferably within a range of 10 wt % to 25 wt %, inclusive.

Examples of the non-magnetic inorganic powders other than carbon black include needle-shaped non-magnetic iron oxides (α-Fe₂O₃ and α-FeOOH), calcium carbonate (CaCO₃), titanium oxide (TiO₂), barium sulfate (BaSO₄), and α-alumina (α-Al₂O₃), and these non-magnetic powders can be used singly or in combination. Further, it is preferable that the mixing ratio between carbon black and the non-magnetic inorganic powder other than carbon black is within a range of 30/70 to 5/95, inclusive, in terms of weight ratio (carbon black/non-magnetic powder). In this case, if the mixing ratio of carbon black is less than 5 parts by weight per a total of 100 parts by weight of carbon black and the non-magnetic inorganic powder other than carbon black, there arises a problem of an increase in surface electrical resistance or a rise in light transmittance.

Examples of the electron beam curing binder include polyurethane resins, (meth)acrylic resins, polyester resins, vinyl chloride-based copolymers (vinyl chloride-epoxy-based copolymers, vinyl chloride-vinyl acetate-based copolymers, vinyl chloride-vinylidene chloride copolymers), acrylonitrile-butadiene-based copolymers, polyamide resins, polyvinyl butyral-based resins, nitrocellulose, styrene-butadiene-based copolymers, polyvinyl-alcohol resins, acetal resins, epoxy-based resins, phenoxy-based resins, polyether resins, polyfunctional polyethers such as polycaprolactone, polyamide resins, polyimide resins, phenol resins, and resins obtained by modifying a polybutadiene elastomer and the like to an electron beam curing type. In the present magnetic tape 1 (lower non-magnetic layer 2), a vinyl chloride-based copolymer and a polyurethane-based resin are used as the electron beam curing binder, for example.

The vinyl chloride-based copolymers preferably have a vinyl chloride content within a range of 40 wt % to 95 wt %, particularly within a range of 50 wt % to 90 wt % is preferable, and an average polymerization degree within a range of 100 to 500, inclusive. In particular, a copolymer of vinyl chloride and a monomer having an epoxy (glycidyl) is preferable as the vinyl chloride-based copolymers. The vinyl chloride-based copolymers are of an electron beam curing type obtained by modification through introduction of e.g., a (meth)acrylic double bond by a known method. Further, the polyurethane resin in the present invention is the generic name for resins obtained through reaction between a hydroxy group-containing resin, such as a polyesterpolyol resin and/or a polyetherpolyol resin, and a polyisocyanate-containing compound, and having a number-average molecular weight within a range of 5,000 to 200,000 and a Q-value (weight-average molecular weight/number-average molecular weight) within a range of 1.5 to 4, inclusive. The polyurethane resins are of an electron beam curing type obtained by modification through introduction of a (meth)acrylic double bond by a known method.

Further, the content of the electron beam curing binder in the lower non-magnetic layer 2 is preferably within a range of 10 parts by weight to 100 parts by weight, more preferably within a range of 12 parts by weight to 30 parts by weight, inclusive, per a total of 100 parts by weight of carbon black and the non-magnetic inorganic powder other than carbon black in the lower non-magnetic layer 2. If the content of the electron beam curing binder is too small, the ratio of the electron beam curing binder in the lower non-magnetic layer 2 becomes too low to obtain a sufficient coating film strength. On the other hand, if the binder content is too large, a tape-shaped medium, such as a magnetic tape, is likely to be strongly bent in the width direction of the tape, which causes degradation of the contact with the magnetic head.

As the dispersant, a resin is suitable which contains an amine group (at least one of a primary amine group (—NH₂), a secondary amine group, and a tertiary amine group) as a polar group. Such a resin is highly reactive with a thermosetting agent, which is effective in enhancing crosslinking property of the lower non-magnetic layer 2. Particularly in the case of using a dispersant together with an electron beam curing binder, the dispersant is required to have a high reactivity with a thermosetting agent so as to obtain a high crosslinking property. The dispersant content in the lower non-magnetic layer 2 is set within a range of 1 part by weight to 6 parts by weight, inclusive, per a total of 100 parts by weight of the non-magnetic powders. If the dispersant content is too small, dispersion cannot be performed sufficiently, which not only causes degradation of the surface property of the lower non-magnetic layer 2, but also makes crosslinking reaction insufficient, resulting in insufficient coating film strength. On the other hand, if the dispersant content is too large, crosslinking reaction with the thermosetting agent is promoted, and hence the stability of the non-magnetic coating material is impaired. In this case, as the resin containing an amine group as a polar group, there may be mentioned at least one anion surfactant selected from carboxylic acid amine salts, phosphoric acid ester amine salts, and polyester acid amide amine salts.

As the thermosetting agent, there may be suitably used those which contain an organic compound having a isocyanate group (NCO) and have a curing reaction property of being reactive with the thermosetting reactive group in the above described dispersant via the isocyanate group thereof. Preferably, the thermosetting agent content is within a range of 0.2 parts by weight to 2 parts by weight, inclusive, per 1 part by weight of the dispersant in the lower non-magnetic layer 2. If the thermosetting agent content is too small, crosslinking reaction cannot be performed sufficiently, and hence a sufficient coating film strength cannot be obtained. On the other hand, if the thermosetting agent content is too large, the crosslinking property becomes too high, causing degradation of contact with the magnetic head or other problems. As the crosslinking agent, there may be used polyisocyanate oligomers (isocyanurate curing agents) containing a general isocyanurate ring in the molecule, and as examples thereof, there may be mentioned diisocyanate compounds, such as TDI (tolylene diisocyanate), MDI (diphenyl methane diisocyanate), IPDI (isophorone diisocyanate), HDI (hexamethylene diisocyanate), XDI (xylylene diisocyanate), hydrogenated XDI, o-phenylene diisocyanate, m-phenylene diisocyanate, and p-phenylene diisocyanate, and oligomers of these diisocyanate compounds.

Further, various known resins can be contained in the lower non-magnetic layer 2 within an amount of not more than 20 wt % of the electron beam curing binder (vinyl chloride-based copolymer and polyurethane resin). For example, an electron-beam curing polyfunctional monomer, preferably a polyfunctional (meth)acrylate, can be contained as the crosslinking agent in the lower non-magnetic layer 2, as required, to thereby improve the crosslinking ratio of the electron beam curing binder. In this case, the polyfunctional (meth)acrylate is not particularly limited, but there may be used, for example, ethylene glycol di(meth)acrylate, diethylene glycol di(meth)acrylate, polyethylene glycol di(meth)acrylate, 1,6-hexane glycol di(meth)acrylate, pentaerythritol tetra(meth)acrylate, trimethylol propane tri(meth)acrylate, and trimethylol propane di(meth)acrylate.

Further, a lubricant can be contained in the lower non-magnetic layer 2 as required. More specifically, as the lubricant, there may be used fatty acids such as a stearic acid and a myristic acid, fatty esters such as butyl stearate and butyl palmitate, saccharides, and other known lubricants, and they can be used singly or in combination of two or more of them, irrespective of whether they are saturated or unsaturated. It is also preferable that two or more fatty acids with different melting points are used in combination and that two or more fatty esters with different melting points are used in combination. The reason of this is that it is necessary to continuously provide the surface of the magnetic tape 1 with lubricants suited for any temperature environment where the magnetic tape 1 is used. Further, although the lubricant content in the lower non-magnetic layer 2 can be adjusted as required depending on purposes, it is preferably set within a range of 1 wt % to 20 wt %, inclusive, per a total weight of carbon black and the non-magnetic powder other than carbon black in the lower non-magnetic layer 2.

The non-magnetic coating material for forming the lower non-magnetic layer 2 is prepared by a known method, i.e., by adding organic solvents to the above-mentioned components and carrying out mixing, agitation, kneading, dispersion, etc. Organic solvents that can be used are not particularly limited, but one or more of various kinds of solvents including ketone solvents such as methyl ethyl ketone (MEK), methyl isobutyl ketone, and cyclohexanon, and aromatic solvents such as toluene, may be selectively used as required. The amount of the organic solvent to be added can be set within a range of 100 parts by weight to 900 parts by weight, inclusive, per a total of 100 parts by weight of the solids (carbon black and the non-magnetic inorganic powder other than carbon black), the electron beam curing binder, the dispersant, and the thermosetting agent.

(Magnetic Layer)

The magnetic layer 3 is formed by being coated with a magnetic coating material containing materials such as a ferromagnetic powder and a binder, so that it has a thickness within a range of 0.03 μm to 0.30 μm, preferably within a range of 0.05 μm to 0.25 μm, inclusive (e.g., a thickness of approximately 0.10 μm) If the magnetic layer 3 is too thick, self-demagnetization loss or thickness loss increases. Therefore, it is necessary to set the thickness in the above-mentioned range.

In this case, it is preferable that a metal magnetic powder or a hexagonal plate fine powder is used as the ferromagnetic powder. The metal magnetic powder preferably has a coercive force Hc within a range of 118.5 kA/m to 237 kA/m (1500 Oe to 3000 Oe), a saturation magnetization σs within a range of 90 Am²/kg to 160 Am²/kg (emu/g), an average major axis length (average major axis diameter) within a range of 0.03 μm to 0.1 μm, an average minor axis length (average minor axis diameter) within a range of 7 nm to 20 nm, and an aspect ratio within a range of 1.2 to 20, inclusive. Further, it is preferable that the coercive force Hc of the magnetic tape 1 formed using the metal magnetic powder is within a range of 118.5 kA/m to 237 kA/m (1500 Oe to 3000 Oe), inclusive. As additive elements for the ferromagnetic powder, there may be added Ni, Zn, Co, Al, Si, Y, and other elements including rare earth elements, depending on the purpose. The hexagonal plate fine powder preferably has a coercive force Hc within a range of 79 kA/m to 237 kA/m (1000 Oe to 3000 Oe), a saturation magnetization σs within a range of 50 Am²/kg to 70 Am²/kg (emu/g), an average plate particle diameter within a range of 30 nm to 80 nm, and a plate ratio within a range of 3 to 7, inclusive. Further, it is preferable that the coercive force Hc of the magnetic tape 1 formed using the hexagonal crystal plate fine powder is within a range of 94.8 kA/m to 238.7 kA/m (1200 Oe to 3000 Oe), inclusive. As additional elements for the hexagonal crystal plate fine powder, there may be added Ni, Co, Ti, Zn, Sn, and other rare earth elements depending on the purpose.

The average major axis length of a ferromagnetic powder can be obtained by measuring the major axis length of the ferromagnetic powder in a photograph of the ferromagnetic powder which is taken by a transmission electron microscope (TEM) after being separated and collected from a tape piece of the magnetic tape 1. An example of this procedure will be described below.

(1) The back coat layer 5 is wiped off from the tape piece with a solvent.

(2) A sample of the tape piece having the lower non-magnetic layer 2 and the magnetic layer 3 left on the base film 4 is soaked in a 5% NaOH solution, heated, and agitated.

(3) A coating film separated from the base film 4 is washed with water and dried. (4) The dried coating film is subjected to ultrasonic process in methyl ethyl ketone (MEK), and magnetic powder is absorbed and collected using a magnet stirrer.

(5) Magnet powder is separated from a residue and dried.

(6) The ferromagnetic powder obtained in the steps (4) and (5) is collected in a special mesh to prepare a TEM sample, and the TEM sample is photographed by the TEM.

(7) The major axis length of the ferromagnetic powder in the photograph is measured and averaged (number of times of measurement: n=100).

It suffices that the ferromagnetic powder is contained in the composition of the magnetic layer 3 in an amount of around 70 wt % and 90 wt %. If the ferromagnetic powder content is too large, the binder content is reduced, and hence surface smoothness obtained by calendering is likely to be degraded. On the other hand, if the ferromagnetic powder content is too small, it is difficult to obtain a high reproduction output.

The binder for the magnetic layer 3 is not particularly limited, but it is possible to use a combination of thermoplastic resins, thermosetting or reactive resins, electron beam curing binders, and so forth, depending on the characteristics of the magnetic tape 1 and processing conditions.

The content of the binder for use in the magnetic layer 3 is preferably set within a range of 5 parts by weight to 40 parts by weight, more preferably within a range of 10 parts by weight to 30 parts by weight, inclusive, per 100 parts by weight of the ferromagnetic powder. If the binder content is too small, the strength of the magnetic layer 3 is reduced, and hence the running durability is likely to be degraded. On the other hand, if the binder content is too large, the ferromagnetic powder content is reduced, and hence electromagnetic conversion characteristics of the magnetic layer 3 are likely to be degraded.

Further, from the viewpoint of enhancement of the mechanical strength of the magnetic layer 3 and prevention of clogging of the magnetic head, it is preferable to cause the magnetic layer 3 to contain an abrasive having a Mohs hardness of not less than 6, such as α-alumina (Mohs hardness of 9). Normally, such abrasives have irregular shapes, and not only prevent clogging of the magnetic head but also enhance the mechanical strength of the magnetic layer 3.

It is preferable that the abrasive has an average particle diameter thereof set within a range of 0.01 μm to 0.2 μm, more preferably within a range of 0.05 μm to 0.2 μm, inclusive. If the average particle diameter is too large, the amount of projection of the abrasive from the surface of the magnetic layer 3 becomes too large, which can cause degradation of electromagnetic conversion characteristics, an increase in dropout, and an increase in the amount of wear of the magnetic head. On the other hand, if the average particle diameter is too small, the amount of projection of the abrasive from the surface of the magnetic layer 3 becomes too small, which makes it difficult to obtain a sufficient effect of preventing clogging of the magnetic head.

Normally, the average particle diameter of the abrasive is measured by a transmission electron microscope. The content of the abrasive is set within a range of 3 parts by weight to 25 parts by weight, preferably within a range of 5 parts by weight to 20 parts by weight, inclusive, per 100 parts by weight of the ferromagnetic powder. Further, a dispersant such as a surface active agent, a lubricant such as a higher fatty acid, a fatty ester, and silicone oil, and various other additives may be added to the magnetic layer 3.

The magnetic coating material for forming the magnetic layer 3 is prepared by s known method, i.e., by adding organic solvents to the above mentioned components and carrying out mixing, agitation, kneading, dispersion, etc. Organic solvents that can be used are not particularly limited, but it is possible to employ the same solvents as used for the lower non-magnetic layer 2.

A center line average roughness Ra on the surface of the magnetic layer 3 is preferably set within a range of 1.0 nm to 5.0 nm, more preferably within a range of 1.0 nm to 4.0 nm, inclusive. If the center line average roughness Ra is less than 1.0 nm, the surface of the magnetic layer 3 is too smooth, which degrades the running stability, and troubles are liable to occur during running of the tape. On the other hand, if the center line average roughness Ra is more than 5.0 nm, the surface of the magnetic layer 3 becomes rough, which causes degradation of the electromagnetic conversion characteristics, including reproduction output.

(Back Coat Layer)

The back coat layer 5 is provided, as required, for improvement of running stability and prevention of the magnetic layer from being electrically charged. Although the construction and composition of the back coat layer 5 are not particularly limited, the back coat layer 5 can be formed, for example, such that it contains carbon black, a non-magnetic inorganic powder other than carbon black, and a binder. In this case, it is preferable that the back coat layer 5 contains carbon black within a range of 30 wt % to 80 wt %, inclusive. Further, needle-shaped non-magnetic iron oxide (such as α-Fe₂O₃ and α-FeOOH), CaCo₃, TiO₂, BaSO₄, and α-Al₂O₃ may be used as the non-magnetic inorganic powders other than carbon black, whereby the mechanical strength of the back coat layer 5 can be adjusted to a desired value.

Coating material (back coat layer coating material) for forming the back coat layer 5 is prepared by a known method, i.e., by adding organic solvents to the above mentioned components and carrying out mixing, agitation, kneading, dispersion, etc. Organic solvents that can be used are not particularly limited, but it is possible to use the same solvents as used for the lower non-magnetic layer 2.

The thickness of the back coat layer (after calendering) is set to not more than 1.0 μm, preferably within a range of 0.1 μm to 1.0 μm, and more preferably within a range of 0.2 μm to 0.8 μm, inclusive.

(Manufacturing of the Magnetic Tape 1)

The magnetic tape 1 shown in FIG. 1 is manufactured by forming the lower non-magnetic layer 2, the magnetic layer 3, and the back coat layer 5 on the base film 4, using the non-magnetic coating material, the magnetic coating material, and the back coat layer coating material, respectively prepared as described above, by carrying out processing including coating, drying, calendering, and curing.

In this case, the lower non-magnetic layer 2 and the magnetic layer 3 are formed by a so-called wet-on-dry coating method. More specifically, first, the non-magnetic coating material is applied to one surface of the base film 4 and dried, and calendered if necessary, to thereby form an uncured lower non-magnetic layer 2. Then, the uncured lower non-magnetic layer 2 is irradiated with an electron beam with an irradiation dose within a range of 1.0 Mrad to 6.0 Mrad, inclusive, to cure the lower non-magnetic layer 2. Next, the magnetic coating material is applied on the cured lower non-magnetic layer 2, and then orientation processing and drying processing are executed, to thereby form the magnetic layer 3. It should be noted that the position of the step of forming the back coat layer 5 in the manufacturing process can be determined as desired. More specifically, the back coat layer 5 can be formed before formation of the lower non-magnetic layer 2, between completion of formation of the lower non-magnetic layer 2 and the start of formation of the magnetic layer 3, or after completion of formation of the magnetic layer 3. Further, the magnetic layer 3 and the back coat layer 5 are calendered, for example, after the magnetic layer 3 and the back coat layer 5 are both dried.

Various known coating methods, such as gravure coating, reverse roll coating, die nozzle coating, and bar coating, can be employed as the coating method for coating the non-magnetic coating material, the magnetic coating material, and the back coat layer coating material.

As described heretofore, according to the magnetic tape 1, since the lower non-magnetic layer 2 is formed using the non-magnetic coating material that contains an electron beam curing binder as a binder as well as a dispersant having an amine group and a thermosetting agent, it is possible to form the magnetic layer 3 by the so-called wet-on-dry coating method on the lower non-magnetic layer 2 cured by an electron beam, which make it possible to realize a magnetic tape having excellent surface smoothness and electromagnetic conversion characteristics. Further, crosslinking reaction between the dispersant having the amine group and the thermosetting agent due to thermosetting can be utilized to further cure the lower non-magnetic layer 2 and enhance the strength thereof. Therefore, the Young's modulus of the whole magnetic tape 1 can be maintained not less than a specified value even when the film thickness of the base film 4 is reduced, which makes it possible to further increase the recording capacity of the magnetic tape 1.

### EXAMPLES

Next, the magnetic tape 1 according to the present invention will now be described in detail based on Examples.

### Example 1

(Preparation of the non-magnetic coating material) A non-magnetic powder: needle-shaped α-FeOOH 80.0 parts by weight (average major axis length: 0.1 μm; and crystallite diameter: 12 nm), A non-magnetic powder: carbon black 20.0 parts by weight (manufactured by Mitsubishi Chemical Corporation; trade name: #950B; average particle diameter: 17 nm; BET specific surface area: 250 m²/g; DBP oil absorption: 70 ml/100 g; pH: 8), Electron beam curing binder: electron-beam curing vinyl chloride resin 12.0 parts by weight (manufactured by TOYOBO CO., LTD.; trade name: TB-0246; (solid content) vinyl chloride-epoxy containing monomer copolymer; average polymerization degree: 310, content of S based on the use of potassium persulfate: 0.6% (wt %); MR110 manufactured by Nippon Zeon Co., Ltd and acryl-modified using 2-isocyanatoethyl methacrylate (MOI), acryl content: 6 mol/l mol), Electron beam curing binder: electron-beam curing polyurethane resin 10.0 parts by weight (manufactured by TOYOBO CO., LTD.; trade name: TB-0216, (solid content) hydroxy-containing acrylic compound—phosphonic acid group-containing phosphorus compound—hydroxy-containing polyester polyol; average molecular weight: 13,000; P content: 0.2% (wt %); acryl content: 8 mol/1 mol), Dispersant: high molecular weight polyester acid amide amine salt 1.0 part by weight (manufactured by TOHO Chemical Industry Co., LTD.; trade name: DA-7500), and Abrasive: α-alumina 5.0 parts by weight (manufactured by Sumitomo Chemical Co., Ltd.; trade name: HIT60A; average particle diameter: 0.18 μm) NV (solid concentration)=33% (mass percentage) and Solvent ratio: MEK/toluene/cyclohexanon=2/2/1 (mass ratio)

The above-mentioned materials were kneaded by a kneader, and then the kneaded mixture was dispersed by a horizontal pin mill filled with 0.8 mm zirconia beads at a filling ratio of 80% (void ratio of 50 vol %). Thereafter, Lubricant: fatty acid 1.0 parts by weight (manufactured by NOF CORPORATION; trade name: NAA180), Lubricant: fatty acid amide 0.5 parts by weight (manufactured by KAO CORPORATION; trade name: Fatty Acid Amide S), and Lubricant agent: fatty ester 1.5 parts by weight (manufactured by Nikko Chemicals Co., Ltd.; trade name: NIKKOLBS) were further added and diluted such that NV (solid concentration)=25% (mass percentage) and Solvent ratio: MEK/toluene/cyclohexanon=2/2/1 (mass ratio) hold, and dispersion was carried out. Then, the obtained coating material was filtered through a filter with an absolute filtration accuracy of 3.0 μm to thereby prepare a non-magnetic coating material.

Next, 0.2 parts by weight of a thermosetting agent (Colonate L manufactured by NIPPON POLYURETHANE INDUSTRY Co., LTD.) was added to the prepared non-magnetic coating material and mixed therewith, and then the non-magnetic coating material was further filtered through a filter with an absolute filtration accuracy of 1.0 μm to thereby prepare the non-magnetic coating material according to the present invention.

(Preparation of the magnetic coating material) Ferromagnetic powder: Fe-based needle-shaped ferromagnetic powder 100.0 parts by weight (Fe/Co/Al/Y=100/24/5/8 (atomic ratio); Hc: 188 kA/m; σs: 140 Am²/kg; BET specific surface area: 50 m²/g; average major axis length: 0.10 μm), Binder: vinyl chloride copolymer 10.0 parts by weight (manufactured by Nippon Zeon Co., Ltd.; trade name: MR110), Binder: polyester polyurethane 6.0 parts by weight (manufactured by Toyobo Co., Ltd.; trade name: UR8300), Dispersant: phosphoric acid surfactant 3.0 parts by weight (manufactured by TOHO Chemical Industry Co., LTD.; trade name: RE610) Abrasive: α-alumina 10.0 parts by weight (manufactured by Sumitomo Chemical Co., Ltd.; trade name: HIT60A; average particle diameter: 0.18 μm) NV (solid concentration)=30% (mass percentage) Solvent ratio: MEK/toluene/cyclohexanon=4/4/2 (mass ratio).

The above-mentioned materials were kneaded by a kneader, and the kneaded material was pre-dispersed by a horizontal pin mill filled with 0.8 mm zirconia beads at a filling ratio of 80% (void ratio of 50 vol %). Next, the pre-dispersed material was diluted such that NV (solid concentration)=15% (mass percentage), and Solvent ratio: MEK/toluene/cyclohexan=22.5/22.5/55 (mass ratio) hold, and then finishing dispersion was carried out. Next, 10 parts by weight of a thermosetting agent (Colonate L manufactured by NIPPON POLYURETHANE INDUSTRY Co., LTD.) was added to the obtained coating material and mixed therewith, whereafter the coating material was filtered through a filter with an absolute filtration accuracy of 1.0 μm to thereby prepare the magnetic coating material.

(Preparation of the back coat layer coating material) Carbon black 75 parts by weight (manufactured by Cabot Corporation; trade name: BP-800; average particle diameter: 17 nm; BET specific surface area: 210 m²/g), Carbon black 10 parts by weight (manufactured by Cabot Corporation; trade name: BP-130; average particle diameter: 75 nm; DBP oil absorption: 69 ml/100 g; BET specific surface area: 25 m²/g), Barium sulfate 15 parts by weight (manufactured by SAKAI CHEMICAL INDUSTRY CO., LTD.; trade name: Barifine BF-20; average particle diameter: 30 nm),

| | | |
|---|---|---|
| Nitrocellulose | 80 | parts by weight |
| (manufactured by Asahi Kasei Corporation; | | |
| trade name: BTH1/2), | | |
| Polyurethane resin | 40 | parts by weight |
| (manufactured by Toyobo Co., Ltd.; trade | | |
| name: UR-8300; containing sulfonic acid Na), | | |
| Methyl ethyl ketone | 150 | parts by weight, |
| Toluene | 150 | parts by weight, |
| Cyclohexanon | 80 | parts by weight |

The above-mentioned materials were sufficiently kneaded by a kneader, and then the obtained composition was subjected to dispersion by a sand grind mill for five hours and then the following materials:

| | | |
|---|---|---|
| Methyl ethyl ketone | 400 | parts by weight, |
| Toluene | 400 | parts by weight, and |
| Cyclohexanon | 200 | parts by weight |

were added, and then dispersion was carried out by the sand grind mill for another hour.

20 parts by weight of a thermosetting agent (Colonate L manufactured by NIPPON POLYURETHANE INDUSTRY Co., LTD.) was added to the thus obtained mixed solution and mixed therewith, and the obtained coating material was filtered through a filter with an absolute filtration accuracy of 1.0 μm to thereby prepare the back coat layer coating material.

(Process of Forming the Lower Non-magnetic Layer)

The non-magnetic coating material was applied to one surface of the PEN base film 4 with a thickness of 6.2 μm using a nozzle by an extrusion coating method so that a thickness of 2.0 μm can be obtained after calendering, and then dried. Thereafter, processing was carried out using a calender constructed by combining a plastic roll and a metal roll, passing through the nip four times, at a processing temperature of 100° C., under a linear pressure of 3500 N/cm, and at a speed of 150 m/minute, and then electron beam irradiation was carried out with an irradiation dose of 4.0 Mrad to form the lower non-magnetic layer 2.

(Process of Forming the Magnetic Layer)

The magnetic coating material was applied to the lower non-magnetic layer 2 formed as above, using a nozzle so that a thickness of 0.1 μm can be obtained after processing, and then orientation processing and drying processing were executed. Thereafter, processing was carried out using a calender constructed by combining a plastic roll and a metal roll, passing through the nip four times, at a processing temperature of 100° C., under a linear pressure of 3500 N/cm, and at a speed of 150 m/minute to form the magnetic layer 3.

(Process of Forming the Back Coat Layer)

The back coat layer coating material was applied to the other surface of the PEN base film 4 using a nozzle so that a thickness of 0.5 μm can be obtained after processing, and then drying processing was executed. Thereafter, processing was carried out using a calender constructed by combining a plastic roll and a metal roll, through the nip four times, at a processing temperature of 90° C., under a linear pressure of 2100 N/cm, and at a speed of 150 m/minute to form the back coat layer 5.

The PEN base film 4 having undergone the above described series of processing was wound up by a winding roll and left to stand in this state for 24 hours. Then, the PEN base film 4 was thermally cured at 60° C. for 48 hours, and cut to a width of ½ inch (=12.650 mm). Thus, a magnetic tape sample was formed as Example 1.

### Examples 2 to 9

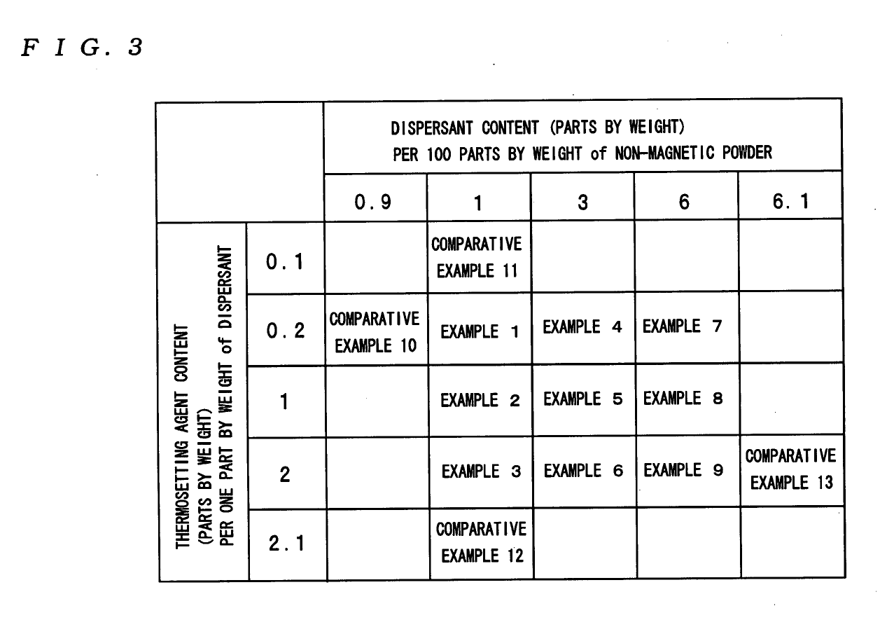

Samples of magnetic tapes as respective Examples 2 to 9 were made in the same manner as in Example 1, except that in the preparation of the non-magnetic coating material, the dispersant content per 100 parts by weight of the non-magnetic powder and the thermosetting agent content per 1 part by weight of the dispersant were changed as shown in FIG. 3.

### Comparative Examples 1 to 9

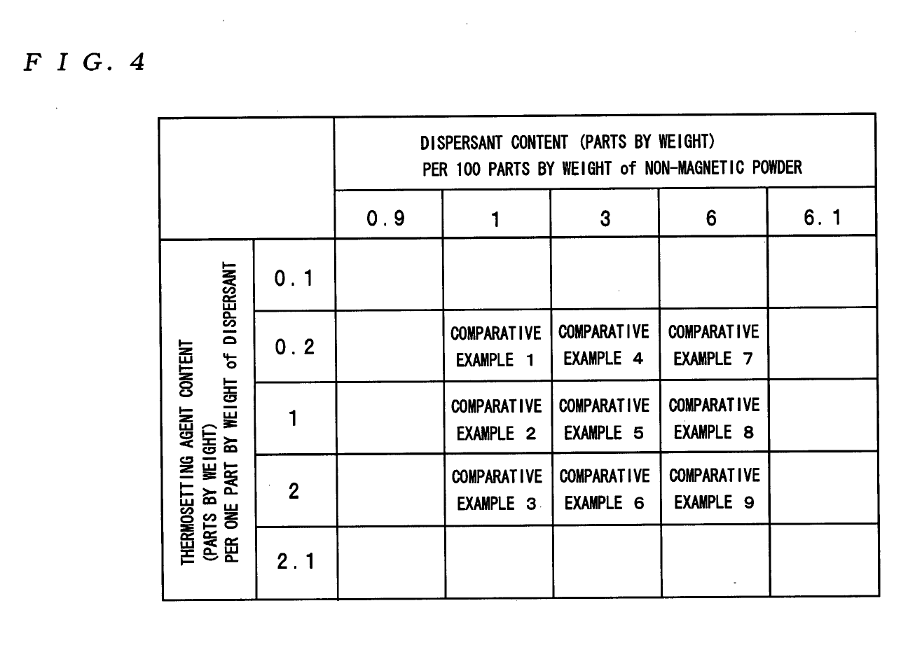

Samples of magnetic tapes as Comparative Examples 1 to 9 were made in the same manner as in Examples 1 to 9, except that a phosphoric acid surfactant (trade name: RE610 manufactured by TOHO Chemical Industry Co., LTD.) which does not contain an amine group as a polar group was used as a dispersant in the non-magnetic coating material in place of the high molecular weight polyester acid amide amine salt. The samples were made while changing the dispersant content per 100 parts by weight of the non-magnetic powder and the thermosetting agent content per 1 part by weight of the dispersant as shown in FIG. 4.

### Comparative Examples 10 to 13

Samples of magnetic tapes as Comparative Examples 10 to 13 were made in the same manner as in Example 1 described above, except that in the preparation of the non-magnetic coating material, the dispersant content per 100 parts by weight of the non-magnetic powder and the thermosetting agent content per 1 part by weight of the dispersant were changed as shown in FIG. 3.

(Evaluation of Magnetic Tapes)

Each of the magnetic tape samples was subjected to evaluation tests regarding two kinds of Young's moduli defined below.

Method of measuring Young's modulus (E1) by a micro hardness tester Measurement was carried out using an ultra-micro indentation hardness tester (trade name: ENT-1100 manufactured by ELIONIX Co., Ltd.). The sample was made by dropping one drop of adhesive (manufactured by Toagosei Co., Ltd.; trade name: Aron Alfa) on a sample holder, affixing a magnetic tape sample cut into a predetermined size on the sample holder with the magnetic layer facing upward, and allowing the magnetic tape sample to stand for six hours under an environment of 28° C. Each value was calculated by averaging eight values obtained by excluding maximum and minimum values from ten values obtained as ten measurement results. Conditions for measurement were set as follows:
indenter shape: ridge angle 115 degrees, triangular pyramid indenter
load: 4 mgf
loading (unloading) speed: 4e⁻⁰⁴ mgf/msec
indentation depth: within 0.1 μm from a surface

A characteristics graph (characteristics graph showing the relationship between load and indentation depth) shown in FIG. 2 was prepared based on the obtained measurement results. Then, depths (indentation depths) obtained as the load was reduced (removed) from a maximum load Pmax to zero were calculated based on the characteristics graph, and the amounts of elastic deformation and plastic deformation of each sample were calculated from the indentation depth. Further, a curve between the maximum load Pmax and a 50% load (Pmax/2) in an unloading region of the characteristics graph is obtained as a quadratic approximate curve, and a tangent to this curve at the maximum load (Pmax) was extended until it intersects the X axis to set the X coordinate of the intersection of the tangent and the X axis as H1. Further, the difference between a maximum displacement point hmax and H1 was set as H2 (=hmax−H1). The values set as above were substituted into the following equation (1) to thereby calculate the Young's modulus E1 (mgf/μm²) on the micro hardness tester:
Young's modulus E1=181.029×10⁻³×Pmax/(H1×H2) (1)

Method of measuring Young's modulus (E2) by a tensile tester Measurement was carried out using a tensile tester (manufactured by ORIENTEC Co., LTD.(former TOYO BALDWIN Co., LTD.); trade name: TENSILON UTM-4-100). A 150-mm long test piece of the magnetic tape sample was fixed to the tensile tester, and jaws (ends of clipping jigs) of the tester were set such that they were spaced 100 mm apart from each other. The separation rate of the jaws was set to 10 mm/minute (corresponding to 10% of the tape length per minute), to measure a distance relative to the applied force. Then, a gradient was obtained between 0.5 N and 1.5 N based on the relationship between the measured force and the measured distance, and the Young's modulus (elastic modulus) E2 (GPa) was calculated using the obtained gradient by the following equation:
Young's modulus E2=(δF/(W×T))×(1/(δL/L)) (2)
wherein δF represents a change (N) in force, T a thickness (mm) of the magnetic tape sample, W a width (mm) of the magnetic tape sample, and δL/L a rate of change in jaw-to-jaw sample length which is obtained by dividing the changed jaw-to-jaw sample length by the original jaw-to-jaw sample length, i.e., the original length between the jaws of the tester.

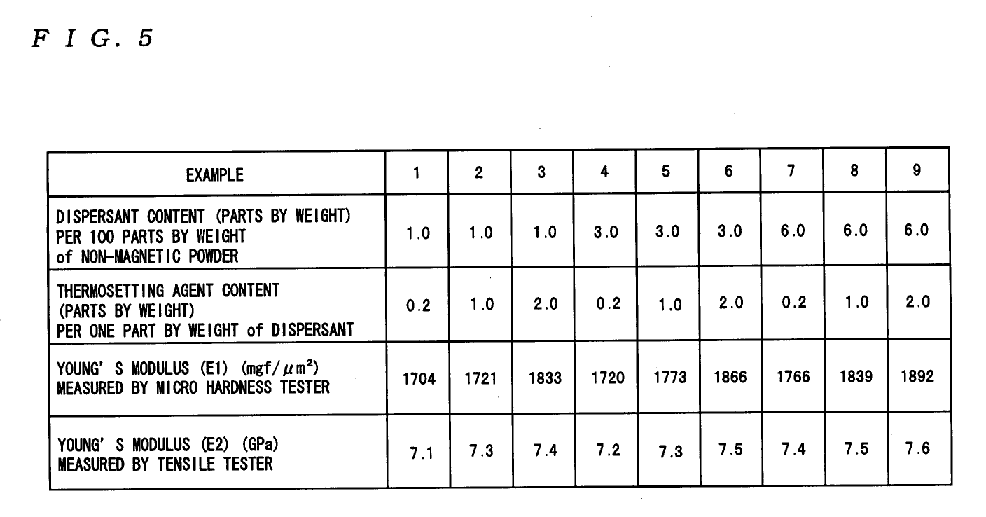

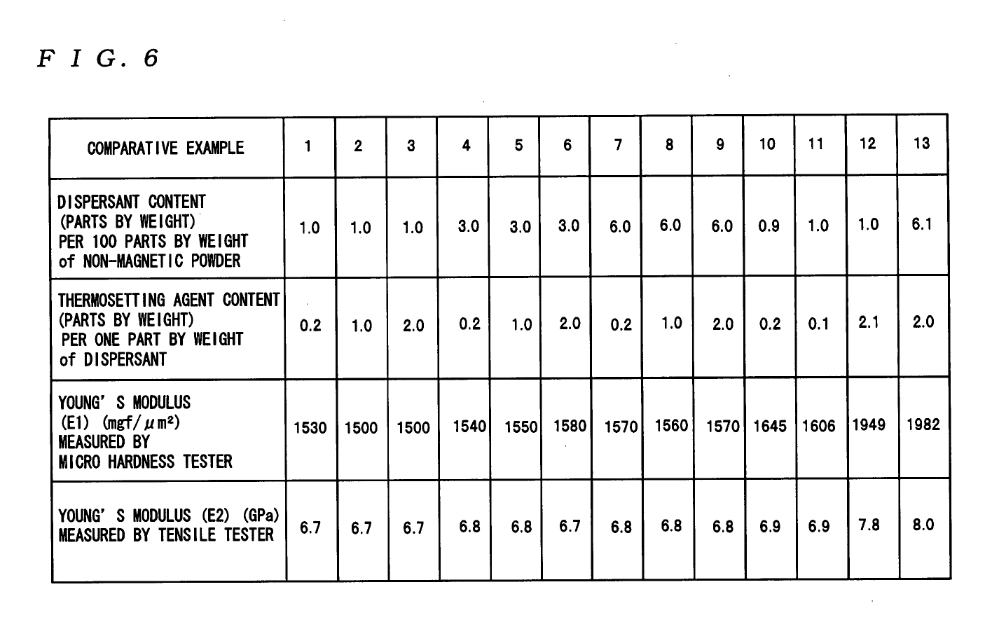

The results of measurement of the Young's moduli in Examples and Comparative Examples are shown in FIGS. 5 and 6. From the results of measurement, it is recognized that the magnetic tape sample in each of Examples 1 to 9 has increased values of the Young's modulus E1 and the Young's modulus E2 and hence has improved physical characteristics compared with the magnetic tape samples in Comparative Examples 1 to 9 which are identical to Examples 1 to 9 in the dispersant content per 100 parts by weight of the non-magnetic powder and the thermosetting agent content per 1 part by weight of the dispersant but are distinguished from Examples 1 to 9 only in that the dispersant which does not contain an amine group as a polar group is used.

On the other hand, the magnetic tape sample in Comparative Example 11 in which the dispersant having the amine group was used as the polar group similarly to the magnetic tape samples in Examples 1, 2 and 3, and at the same time the dispersant content per 100 parts by weight of the non-magnetic powder was 1 part by weight but the thermosetting agent content per 1 part by weight of the dispersant was less than 0.2 parts by weight (specifically, 0.1 parts by weight), and the magnetic tape sample in Comparative Example 10 in which the dispersant having the amine group as the polar group was used similarly to the magnetic tape samples in Examples 1, 4 and 7, and the thermosetting agent content per 1 part by weight of the dispersant was the same 0.2 parts by weight as Examples 1, 4 and 7, but the dispersant content per 100 parts by weight of the non-magnetic powder was less than 1 part by weight (specifically, 0.9 parts by weight) have even smaller values of the Young's modulus E1 and the Young's modulus E2 than the magnetic tape sample in Example 1 in which the values of the Young's modulus E1 and the Young's modulus E2 are smallest in Examples 1 to 9, and hence improvement of the physical characteristics cannot be achieved. On the other hand, the magnetic tape sample in Comparative Example 12 in which the dispersant having the amine group as the polar group was used similarly to the magnetic tape samples in Examples 1, 2 and 3, and the dispersant content per 100 parts by weight of the non-magnetic powder was 1 part by weight but the thermosetting agent content per 1 part by weight of the dispersant was more than 2 parts by weight (specifically, 2.1 parts by weight), and the magnetic tape sample in Comparative Example 13 in which the dispersant having the amine group as the polar group was used similarly to the magnetic tape samples in Examples 3, 6 and 9, and the thermosetting agent content per 1 part by weight of the dispersant was the same two parts by weight as Examples 3, 6 and 9, but the dispersant content per 100 parts by weight of the non-magnetic powder was more than 6 parts by weight (specifically, 6.1 parts by weight) have too large values of the Young's modulus E1 and the Young's modulus E2, and hence the magnetic tape samples in Comparative Examples 12 and 13 lack in flexibility essential to the magnetic tape.

What is claimed is:

1. A magnetic recording medium having at least a lower non-magnetic layer and a magnetic layer formed on one surface of a non-magnetic substrate in the mentioned order,
wherein the lower non-magnetic layer is formed of a non-magnetic coating material containing at least a non-magnetic powder, an electron beam curing binder, a dispersant having an amine group, and a thermosetting agent.

2. A magnetic recording medium according to claim 1, wherein a content of the dispersant is set within a range of 1 part by weight to 6 parts by weight, inclusive, per 100 parts by weight of the non-magnetic powder.

3. A magnetic recording medium according to claim 1, wherein a content of the thermosetting agent is set within a range of 0.2 parts by weight to 2 parts by weight, inclusive, per 1 part by weight of the dispersant.

4. A magnetic recording medium according to claim 2, wherein a content of the thermosetting agent is set within a range of 0.2 parts by weight to 2 parts by weight, inclusive, per 1 part by weight of the dispersant.
